(19) United States
(12) Patent Application Publication
(10) Pub. No.: US 2014/0078005 A1
(43) Pub. Date: Mar. 20, 2014

(54) RADAR ARRAY ANTENNA USING OPEN STUBS

(71) Applicants: Han-Soo Park, Gyeonggi-do (KR); Hak-Kyoun Kim, Seoul (KR); Yaroslav Milyakh, Incheon (KR)

(72) Inventors: Han-Soo Park, Gyeonggi-do (KR); Hak-Kyoun Kim, Seoul (KR); Yaroslav Milyakh, Incheon (KR)

(73) Assignee: ACE TECHNOLOGIES CORPORATION, Incheon (KR)

(21) Appl. No.: 14/119,816

(22) PCT Filed: May 23, 2012
(86) PCT No.: PCT/KR2012/004071

§ 371 Date: Nov. 22, 2013

(30) Foreign Application Priority Data
May 23, 2011 (KR) 10-2011-0048685

(51) Int. Cl. H01Q 9/04

(52) U.S. Cl. CPC H01Q 9/04
USPC 343/700 MS

(57) ABSTRACT

A radar array antenna using open stubs is disclosed. The disclosed antenna includes: a dielectric substrate; a feed line for feeding RF signals that is formed on an upper portion of the dielectric substrate and has a linear form; a multiple number of open stubs that extend at particular angles from the feed line and have linear forms with particular widths; a matching element for adjusting impedance matching that is joined to an end of the feed line; and a ground formed on a lower portion of the dielectric substrate, where the open stubs operate as radiators, and at least one of the open stubs has a different length for adjusting a radiation signal intensity of each open stub. The disclosed antenna can be manufactured with a simple structure and a compact size.

### CROSS-REFERENCE TO RELATED APPLICATIONS

This application is a National Phase Application of PCT International Application No. PCT/KR2012/004071, which was filed on May 23, 2012, and which claims priority from Korean Patent Application No. 10-2011-0048685, filed with the Korean Intellectual Property Office on May 23, 2011. The disclosures of the above patent applications are incorporated herein by reference in their entirety.

### BACKGROUND

1. Technical Field

Embodiments of the present invention relate to a radar antenna, more particularly to a radar array antenna using open stubs.

2. Description of the Related Art

A radar is a device that detects the distance and direction of a remote object or target and information on the surroundings of the target by sending beam signals to the target to receive and analyze the reflected waves.

A radar utilizes the linear directionality and reflective characteristics of radio waves, enabling detection unaffected by darkness, rain, snow, and other circumstances that may reduce visibility, and in recent times, radar devices are also being used in automotive vehicles for gathering various information.

While various types of antennas may be used for a radar antenna, a type of antenna typically used is the microstrip patch antenna.

FIG. 1 illustrates the structure of a radar antenna that uses general microstrip patches according to the related art.

Referring to FIG. 1, a general radar antenna according to the related art may include a substrate 108, a ground 110, a transition conductor 100, a feed line 102, a multiple number of patch radiators 104 and a matching element 106.

The transition conductor 100 may serve to electromagnetically join a waveguide with the feed line 102. Although it is not illustrated in FIG. 1, the transition conductor 100 may join with a waveguide, so that feed signals provided from the waveguide may be provided to the feed line 102.

The multiple patch radiators 104 may be joined on either side of the feed line 102. Each patch radiator may have a rectangular form. Each patch radiator 104 may be joined with an angle of 45 degrees to provide a 45-degree polarization.

FIG. 2 is a magnified view of a radiating patch part of the radar antenna illustrated in FIG. 1.

Referring to FIG. 2, a microstrip patch used in a radar antenna can have a certain width (W) and length (L), where the length of the patch can be approximately ½ of the wavelength corresponding to the usage frequency.

In a radar antenna that uses the conventional microstrip patches illustrated in FIG. 1, each microstrip patch may radiate signals independently, and it may be needed to adjust the power radiated for each radiator. For example, it may be necessary to adjust the signal intensities such that the patches at the center portion radiate signals with the highest power while patches further away from the center portion radiate signals with lower power.

Such adjustment of the signal intensity for each radiator can be achieved by adjusting the width (W) of each radiator.

A portion of the feed signals provided through the feed line 102 may be provided to a radiator while another portion may continue traveling through the feed line, and likewise at the next radiator, a portion may be provided to the radiator while another portion may continue traveling, resulting in radiation occurring at each of the radiators.

The end of the feed line 102 may be joined with the matching element 106, where the matching element may provide impedance matching for the radar antenna to prevent the occurrence of reflections for the signals in the feed line.

As such, a radar antenna according to the related art may entail a complicated structure, with rectangular patches joined to the feed line in a slanted form while maintaining their respective widths, and since the widths of the microstrip patches are increased the further downstream they are of the feed line in order to allow for the distribution of the signal intensities, the increase in size where the matching element 106 is formed can make it difficult to maintain a compact structure.

### SUMMARY

An aspect of the invention is to provide a radar antenna having a simple structure.

Another aspect of the invention is to provide a radar antenna that can be manufactured in a compact structure.

To achieve the objectives above, an embodiment of the invention provides a radar antenna, which includes: a dielectric substrate; a feed line for feeding RF signals that is formed on an upper portion of the dielectric substrate and has a linear form; a multiple number of open stubs that extend at particular angles from the feed line and have linear forms with particular widths; a matching element for adjusting impedance matching that is joined to an end of the feed line; and a ground formed on a lower portion of the dielectric substrate, where the multiple open stubs operate as radiators, and at least one of the open stubs has a different length for adjusting the radiation signal intensity of each open stub.

The open stubs may be set below ¼ of a wavelength or are set to be greater than ¼ of a wavelength and smaller than or equal to ½ of the wavelength.

The open stubs may extend from both sides of the feed line, and the angles between the open stubs and the feed line may be identical.

At least one of the open stubs may be set to have a different width.

Certain embodiments of the invention can provide a radar antenna that has a simple structure and a compact size.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates the structure of a radar antenna that employs a general microstrip patch according to the related art.

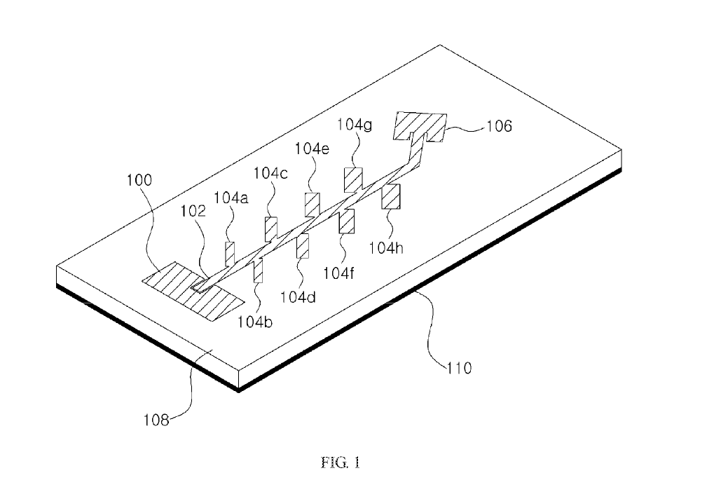

FIG. 2 is a magnified view of a radiating patch part of the radar antenna illustrated in FIG. 1.

FIG. 3 illustrates the structure of a radar antenna using open stubs according to an embodiment of the present invention.

FIG. 4 illustrates the structure of an open stub extending from the feed line according to an embodiment of the present invention.

FIG. 5 is a graph showing S12 parameters at port 1 and port 2 of a feed line for the single open stub illustrated in FIG. 4, and showing radiation gains of the open stub according to changes in the length of the open stub for the single open stub illustrated in FIG. 4.

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the drawings, like reference numerals are used for like elements.

Certain embodiments of the present invention will be described below in more detail with reference to the accompanying drawings.

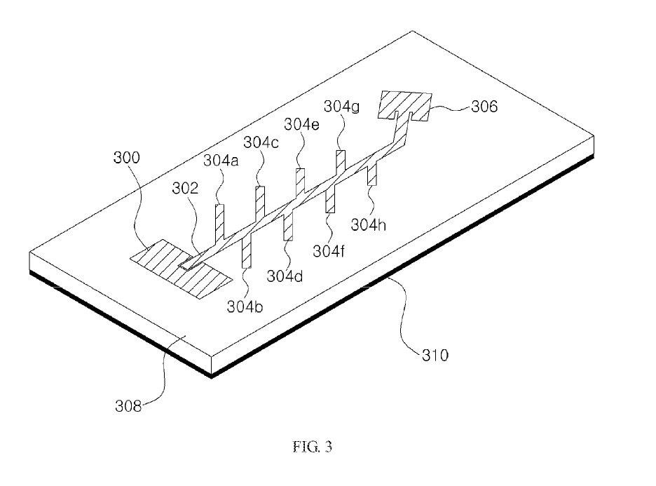

FIG. 3 illustrates the structure of a radar antenna using open stubs according to an embodiment of the present invention.

Referring to FIG. 3, a radar antenna using open stubs according to an embodiment of the present invention can include a transition conductor 300, a feed line 302, multiple open stubs 304a, 304b, 304c, 304d, 304e, 304f, 304g, 304h, a matching element 306, a substrate 308, and a ground 310.

The transition conductor 300, feed line 302, multiple open stubs, and matching element 306 may be formed on an upper portion of the substrate 308, while the ground 310 may be formed on a lower portion of the substrate opposite the upper portion of the substrate.

The transition conductor 300 may electromagnetically join a waveguide with the feed line 302 to provide feed signals to the feed line. The transition conductor 300 and the feed line 302 can be electrically joined directly or can be arranged to allow electromagnetic coupling.

The feed line 302 may have a linear form and may provide the feed signals to the multiple open stubs. In an embodiment of the invention, the multiple open stubs may operate as radiators that radiate and receive radar signals.

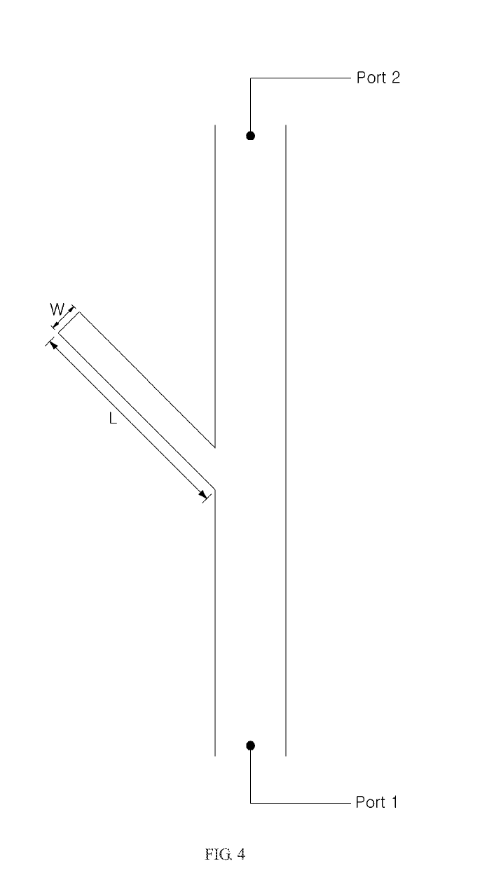

FIG. 4 illustrates the structure of a single open stub extending from the feed line according to an embodiment of the present invention.

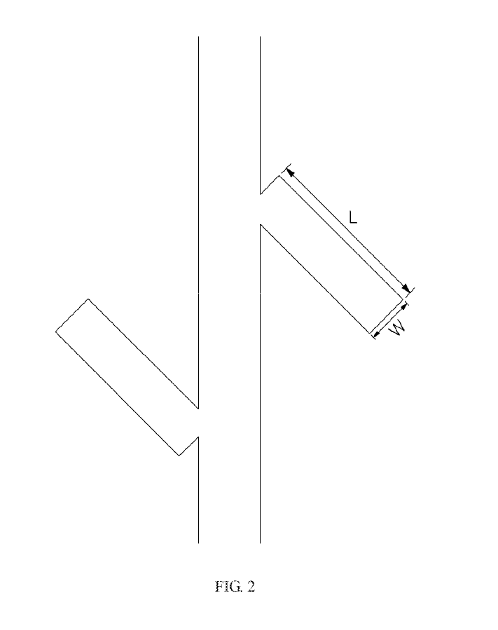

Referring to FIG. 4, the open stub may be structured to extend and protrude from the feed line 302 rather than having an independently rectangular shape as does the microstrip patch illustrated in FIG. 2.

The open stub can have a particular width (W) and length (L), having the form of a line with a particular width protruding at a particular angle, where the protruding angle of the open stub can be set in correspondence to the polarization of the radar antenna.

While FIG. 3 illustrates a structure in which there are eight open stubs 304a, 304b, 304c, 304d, 304e, 304f, 304g, 304h extending from the feed line, the number of open stubs can be suitably adjusted as necessary.

In a radar antenna according to an embodiment of the present invention, it may be necessary to adjust the radiation signal intensity for each open stub in order to obtain a desired radar pattern. For instance, the radiation intensity of each open stub can be adjusted such that radiation signals having the greatest intensities are radiated from the open stubs extending from a center portion of the feed line while radiation signals having the weakest intensities are radiated from the open stubs extending from an end portion of the feed line.

According to an embodiment of the present invention, adjusting the intensity of the radiation signals for each open stub (radiator) may be achieved by adjusting the length of the open stub. Although the intensity of the radiation signals can also be adjusted by the widths of the open stubs, the main parameter for adjusting signal intensity can be the lengths of the open stubs, where the widths of the open stubs can serve as sub-parameters to supplement the adjustment of the signal intensities.

While FIG. 3 illustrates a structure in which the open stubs extend from both sides with respect to the feed line, it is also possible to have a structure in which the open stubs extend from one side of the feed line only.

According to the embodiments of the present invention, the structure in which open stubs form the radiators makes it possible to manufacture a radar with a simpler structure compared to the case of forming radiators with rectangularly shaped patches.

Furthermore, since it is possible to adjust only the lengths of the lines, the adjustment of signal intensity for each radiator can be achieved with greater ease, compared to the antenna using conventional microstrip patches.

The radiation signal intensity of each radiator can be adjusted by the length of each open stub, and when an open stub is used as a radiator as in an embodiment of the present invention, it may be preferably that the open stub have a length equal to or smaller than ½ of the wavelength corresponding to the usage wavelength, in which case it is important to set the length of the open stub such that it does not have a length tantamount to ¼ of the wavelength.

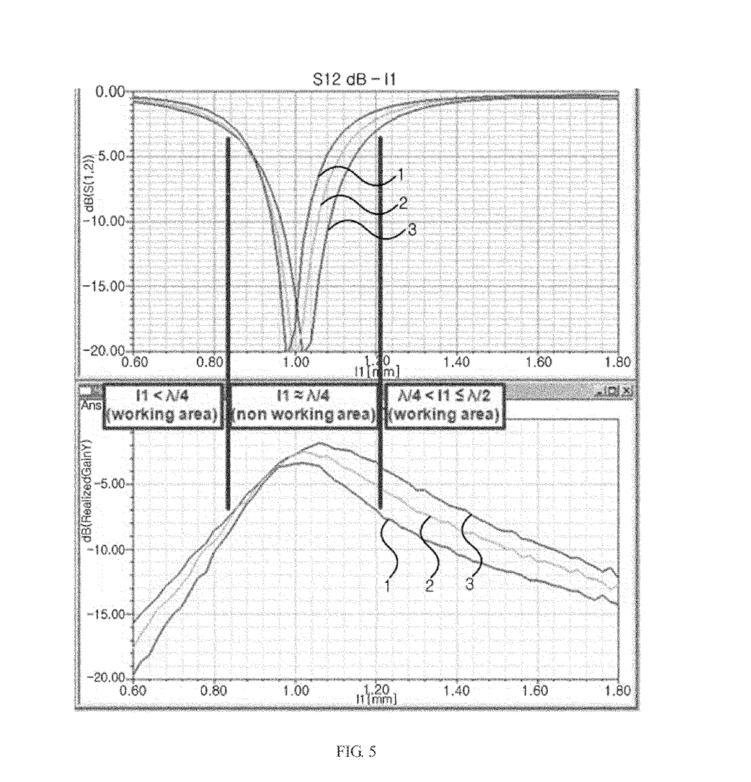

FIG. 5 is a graph showing S12 parameters at port 1 and port 2 of a feed line for the single open stub illustrated in FIG. 4, and showing radiation gains of the open stub according to changes in the length of the open stub for the single open stub illustrated in FIG. 4.

In FIG. 5, the upper graph represents the S12 parameters, while the lower graph represents the radiation gains.

Referring to FIG. 5, it can be seen that the value of the S12 parameter is the lowest when the length of the open stub is approximately ¼ of the wavelength (about 1 mm) This means that when the length of the open stub is ¼ of the wavelength, most of the signals are radiated by the open stubs, and the amount of signals from port 1 that are provided to port 2 is at a minimum.

Also, it can be seen that the radiation gain of the open stub is maximum when the length of the open stub is approximately ¼ of the wavelength (about 1 mm).

FIG. 5 shows simulation results for a single open stub, and if a multiple number of open stubs are used as in an embodiment of the present invention, a concentration of signals on one open stub would make it difficult to suitably distribute the required signal intensities in the RF antenna. Therefore, it may be preferable to set the open stubs to lengths smaller than or equal to ½ of the wavelength in such a way that the length is not equal to or close to ¼ of the wavelength.

While the present invention has been described above using particular examples, including specific elements, by way of limited embodiments and drawings, it is to be appreciated that these are provided merely to aid the overall understanding of the present invention, the present invention is not to be limited to the embodiments above, and various modifications and alterations can be made from the disclosures above by a person having ordinary skill in the technical field to which the present invention pertains. Therefore, the spirit of the present invention must not be limited to the embodiments described herein, and the scope of the present invention must be regarded as encompassing not only the claims set forth below, but also their equivalents and variations.

What is claimed is:

1. A radar antenna comprising:
a dielectric substrate;
a feed line for feeding RF signals, the feed line formed on an upper portion of the dielectric substrate and having a linear form;
a plurality of open stubs extending at particular angles from the feed line and having linear forms with particular widths; and
a ground formed on a lower portion of the dielectric substrate,
wherein the plurality of open stubs operate as radiators, and at least one of the plurality of open stubs has a different length for adjusting a radiation signal intensity of each open stub.

2. The radar antenna of claim 1, wherein the open stubs are set to below ¼ of a wavelength or are set to be greater than ¼ of a wavelength and smaller than or equal to ½ of the wavelength.

3. The radar antenna of claim 1, wherein the open stubs extend from both sides of the feed line, and the angles between the open stubs and the feed line are identical.

4. The radar antenna of claim 1, wherein at least one of the open stubs is set to have a different width.
